(19) United States
(12) Patent Application Publication
(10) Pub. No.: US 2004/0024733 A1
(43) Pub. Date: Feb. 5, 2004

(54) Method for constructing database of technique classification patent map

(76) Inventors: Jeong Wook Won, Daejeon (KR); Hak Seong Jeon, Daejeon (KR); Tae Woong Park, Daejeon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/283,983

(22) Filed: Oct. 30, 2002

(30) Foreign Application Priority Data
Jul. 11, 2002 (KR) 2002-40459

(51) Int. Cl. G06F 7/00

(52) U.S. Cl. 707/1

(57) ABSTRACT

A patent map (PM) database (DB) is constructed by employing a PM technique classification system and a technique classification PM DB. PM related information obtained by accessing a PM related server through Internet is provided and PM related information produced by an operator of the PM technique classification system is generated. A lower rank technique connection point and a higher rank technique connection point are connected between technique classification columns in the DB by using the PM related information, allowing at least one bibliographical data to be described in the lowest technique classification column of the lowest rank and storing technique classification information in the technique classification PM DB.

### FIELD OF THE INVENTION

The present invention relates to a method for constructing a patent map (PM) database (DB); and, more particularly, to a method for constructing a PM DB where a lower rank technique connection point is connected to a higher rank technique connection point by a detail technical tree between columns within the DB and at least one bibliographical data is described in a technique classification column of the lowest rank.

### BACKGROUND OF THE INVENTION

A patent map (PM) serves to classify bibliographical data of a patent, e.g., information upon an applicant, a filing date, a patent number, a technical classification, etc.; analyzes technical contents of the patent such as claims, a detailed description of the invention, a brief description of drawings, etc.; and then visualizes the analyzed information in the form of a diagram in order to help a user read them easily.

A PM is a highly visualized diagram that allows for the user to grasp at a glance a history of a technology, i.e., a technical trend, tendencies in applicants and technical distributions, a complicated interrelationship in patent rights, etc. In the PM, the patent information is analyzed and organized in various ways in order to find any possible drawbacks of the past/existing technologies and to provide a prospect for future technologies that might be conceived by or developed from the current technologies. For this reason, the patent map is referred to as “an analysis diagram of patent information” or as “a patent trend chart”.

The Korean Intellectual Property Office (KIPO) provides a patent information analysis system (PIAS) serving as software for producing a PM. However, the PIAS has a drawback in that it needs to download a search result from a server whenever new data is generated in the process of producing a PM.

For example, a PM showing an annual number of patent applications about a Phase shift key (PSK) type modem can be generated by using the PIAS as follows. First, data related to a key word “PSK” is searched and a search result is downloaded from a server. Then, data having no relation to the PSK is removed from the downloaded data and the PIAS is operated to create the desired PM reflecting the PSK search result.

Likewise, if a PM indicating an annual number of patent applications about a frequency modulation (FM) type modem and a PM exhibiting an annual number of patent applications about an amplitude modulation (AM) type modem are generated, search results for the FM and AM should be downloaded from the server and data having no relation to the FM and the AM should be removed. Then, the PIAS system is operated to produce the desired reflecting the FM and the AM search results.

If a PM about a modulation is generated, all the search result data downloaded from the server should be checked one by one so that data having no relation to the modulation are removed. This removal process is repeatedly performed for every search result data downloaded from the server, which is very troublesome. Further, the PM data created by a certain PM generator cannot be used by another one.

Still further, if an update of an existing PM is required for a long-term research and development project that lasts for about two to three years, the whole PM should be re-generated in order to contain therein newly added data and patent contents.

A PM generation automation method is disclosed in a Korean Patent Laid Open Publication No. 2001-027419 directed to “A method for processing data to analyze a patent/technology and a method for automatically generating a patent map” and a Korean Patent Laid Open Publication No. 2000-061776 entitled “A method for generating a patent map”.

In the Korean Patent Laid Open Publication No. 2001-027419 entitled “A method for processing a data to analyze a patent/technology and a method for automatically generating a patent map”, data of a search file obtained from a patent technology search system is automatically converted by using a computer system into a master table for use in an analysis of patent information or technology information, so that a patent map or a statistical graph of a desired type can be outputted. Further, DB-type master tables are generated based on technical subjects and files searched and classified by the technical subjects are automatically converted into data of a master table by using the computer system. The data of the master table is updated if required. If the user selects a master table corresponding to a specific technical subject, for which a PM is to be outputted, the selected master table is activated. Then, if the user chooses a desired type of the PM, e.g., a matrix map, a road map, etc., the PM of the selected type is automatically displayed on a monitor and, further, can be printed if required.

Next, in the Korean Patent Laid Open Publication No. 2000-061776 entitled “A method for generating a PM”, various types of PMs are automatically produced by using a master table that serves to construct PM technology related information. Specifically, a matrix map type PM and a road map type PM are generated, each of which is provided according to a map-type such as an IPC-year, an IPC-applicant, a technical classification-year, a technical classification-applicant and an applicant-year. Then, data searched from the patent technology search system is structured as a master table based on their technical subjects. Each data is analyzed to create a technical code table for a technical subject and determine a technology classification code and order of importance. The technical classification code and the order of importance are added to the master table. The data is processed to have a desired map type by employing the master table or the combination of the master table and the technical code table, thereby obtaining a matrix map table or a road map table.

As described above, the conventional PM generation methods have drawbacks as follows. First, a PM data created by a specific PM generator cannot be used by another one. Further, the data downloaded from the server should be checked one by one in order to remove therefrom information that has nothing to do with a targeted PM and this data removal process should be repeatedly performed whenever a search data is downloaded from the server.

### SUMMARY OF THE INVENTION

It is, therefore, an object of the present invention to provide a method for constructing a technique classification PM DB where a lower rank technique connection point is connected to a higher rank technique connection point by a detail technical tree between columns in the DB and at least one bibliographical data is described in a technique classification column of the lowest rank.

In accordance with the present invention, there is provided a method for constructing a patent map (PM) database (DB) by employing a PM technique classification system and a technique classification PM DB, the method including the steps of: (a) providing PM related information obtained by accessing a PM related server through Internet and generating PM related information produced by an operator of the PM technique classification system; and (b) connecting a lower rank technique connection point and a higher rank technique connection point between technique classification columns in the DB by using the PM related information, allowing at least one bibliographical data to be described in the lowest technique classification column of the lowest rank and storing technique classification information in the technique classification PM DB.

### BRIEF DESCRIPTION OF THE DRAWINGS

The above and other objects and features of the invention will become apparent from the following description of preferred embodiments given in conjunction with the accompanying drawings, in which:

FIG. 1 is a block diagram of a method for constructing a technique classification patent map (PM) database (DB) in accordance with the present invention;

FIG. 2 illustrates the technique classification PM DB in FIG. 1 having technique classification columns;

FIG. 3 describes a technique classification having a high key structure in accordance with a first embodiment of the present invention; and

FIG. 4 shows a modulation type technique classification in accordance with a second embodiment of the present invention.

### DETAILED DESCRIPTION OF PREFERRED EMBODIMENTS

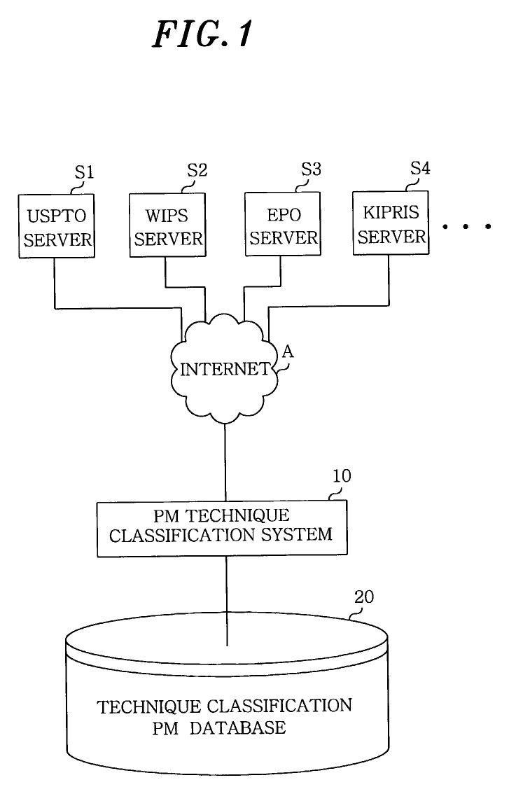

Referring to FIG. 1, there is depicted a block diagram for describing a method for constructing a database (DB) of a technique classification patent map (PM). A PM technique classification system 10 and a technique classification PM DB 20 are prepared.

The PM technique classification system 10 is a personal computer (PC). The PM technique classification system 10 accesses through Internet (A) a server that provides a PM service, i.e., a USPTO (S1) server, a WIPS server (S2), an EPO server (S3), a KIPRIS server (S4), etc., to download PM related information, i.e., bibliographic data, claims, abstracts and detailed descriptions of inventions, etc. Then, the PM technique classification system 10 classifies the downloaded data to obtain technique classification information having a schema structure. The thus obtained technique classification information is provided to the PM DB 20. The technique classification information will be described later in further detail. The PM technique classification system 10 generates PM related information produced by an operator of system 10.

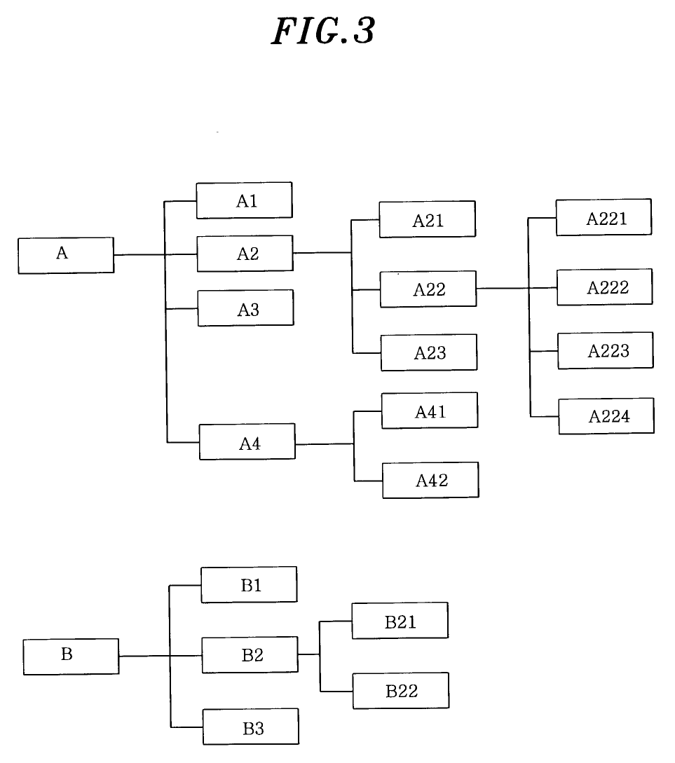

In FIG. 3, there is described the technique classification information having a high key structure. Techniques A and B are fundamentally different from each other and have their own sub-categories. Thus, in order to produce a PM corresponding to a certain technique A2, all the patents belonging to the sub-categories of the technique A2, i.e., techniques A21, A22 and A23, should be considered to produce the desired PM. In other words, if the technique A is selected, all the patents concerned with the technologies A1, A2, A3 and A4 categorized below the technique A are required to be considered in order to create a PM directed to the technique A.

With respect to A2, categories A21, A22 and A23 are defined as first intermediate technique classifications and categories A221, A222, A223 and A224 are referred to as second intermediate technique classifications. Further, A is a highest technique classification of A2. A2 is defined as a first higher technique classification of A22 and A is set to be a second higher technique category thereof.

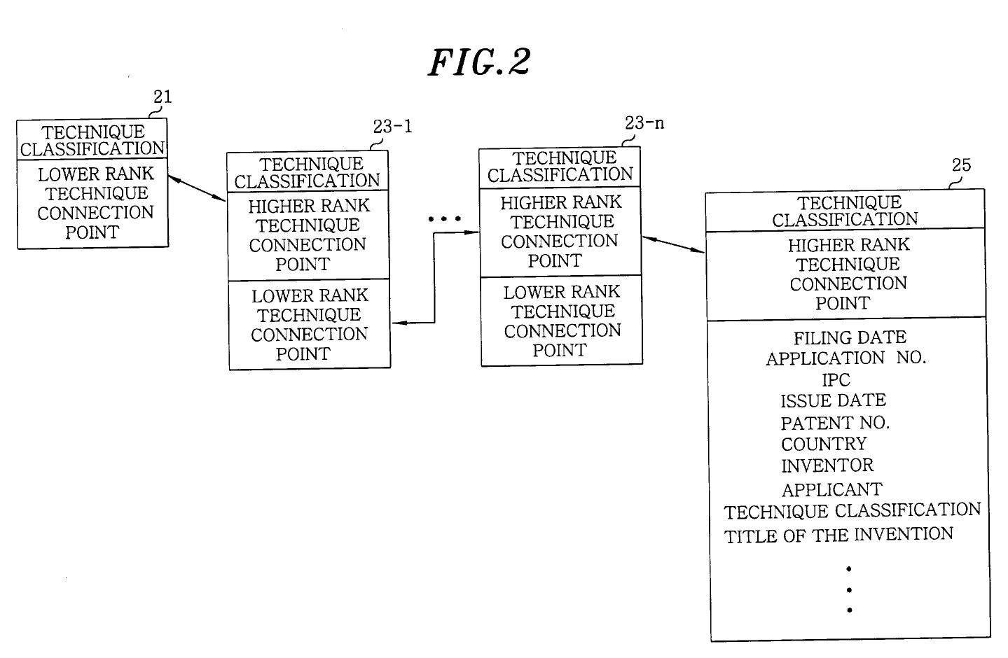

The technique classification PM DB (20) stores therein the technique classification information provided from the PM technique classification system 10. The technique classification information consists of columns configured as shown in FIG. 2.

A highest technique classification category, e.g., A or B in FIG. 3, is linked to an intermediate technique classification category. A lowest technique classification category, i.e., A1, A3, A21, A23, A221, A222, A223, A224, A41 or A 42, is linked to a higher technique classification category and doesn't have any subordinate technique category linked thereto. An intermediate technique classification category, e.g., A2 or A22 in FIG. 3, is linked to both a higher and a lower technique classification category.

Referring to FIG. 2, the PM DB includes a highest technique classification column 21, intermediate technique classification columns 23-1 to 23-n and a lowest technique classification column 25. The lowest technique classification column 25 is required to include a higher rank technique connection point, which is to be linked to lower rank technique connection points in the intermediate technique classification columns 23-1 to 23-n. Further, the lowest technique classification column 25 should include at least one bibliographical data, e.g., a filing date, an application number, an issue date, a patent number, an international patent classification (IPC), an application country, an applicant, an inventor, a publication date, a publication number, etc.

The highest technique classification column 21 should include a lower rank technique connection point to be linked to higher rank technique connection points in the intermediate technique classification columns 23-1 to 23-n. The intermediate technique classification column 23-1 includes both a higher rank technique connection point and a lower rank technique connection point, wherein the higher rank technique connection point is linked to a lower rank technique connection point in the highest technique classification column 21 while the lower rank technique connection point is liked to a higher rank technique connection point in a next intermediate technique classification column 23-2. In case there exists no next intermediate technique classification column 23-2, the lower rank technique connection point of the intermediate technique classification column 23-1 -is linked to a higher rank technique connection point of the lowest technique classification column 25.

Next, a method for constructing a technique-classified PM DB will be described hereinafter in detail.

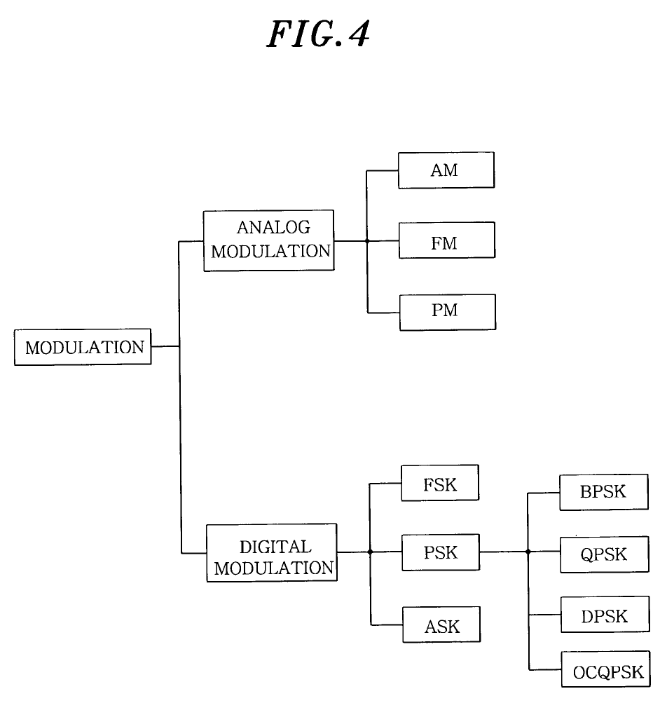

Referring to FIG. 4, there is described a method for subdividing a modulation method having a high key structure into several sub-categories. The modulation method is divided into an analog modulation and a digital modulation. The analog modulation is subdivided into an amplitude modulation (AM), a frequency modulation (FM) and a phase modulation (PM) while the digital modulation is subdivided into a frequency shift keying (FSK), a phase shift keying (PSK) and an amplitude shift keying (ASK).

The AM, FM, PM, FSK, PSK and ASK methods can be divided again into various sub-categories.

For example, the PSK technology, whose higher category is the digital modulation, is subdivided into a DPSK, a BPSK, a QPSK, an OCQPSK, etc.

To be more specific, in producing a PM corresponding to the PSK technology, all the patents directed to the technologies classified below the PSK technology, i.e., the DPSK, the BPSK, the QPSK and the OCQPSK technologies, should be considered for the production of the desired PM. In other words, if the modulation is selected, all the patents dealing with the sub-techniques of the modulation, i.e., the analog modulation and the digital modulation, should be considered to generate a PM of the modulation technology.

Referring back to FIG. 2 and FIG. 4, with respect to the PSK, the categories DPSK, the BPSK, the QPSK and the OCQPSK are the lowermost technique classifications; the digital modulation is a higher technique classification; and the modulation is a highest technique classification. That is to say, the ‘modulation’ in FIG. 4 corresponds to the highest technique classification column 21 in FIG. 2; the AM, the FM, the PM, the FSK, the ASK, the DPSK, the BPSK, the QPSK and the OCQPSK techniques in FIG. 4 respectively correspond to the lowest technique classification column 25 in FIG. 2; and the analog modulation, the digital modulation and the PSK techniques correspond to the intermediate technique classification columns 23-1 to 23-n in FIG. 2.

As can be seen from the above description, the AM, the FM, the PM, the FSK, the ASK, the DPSK, the BPSK, the QPSK and the OCQPSK categories respectively corresponding to the lowest technique classification column 25 should include a higher rank technique connection point and, further, at least one bibliographical data, i.e., a filing data, an application number, an issue date, a patent number, an international patent classification, an applicant, an inventor, a publication date, a publication number, etc.

The technique classification PM DB 20 stores therein technique classification information obtained by the PM technique classification system 10 where the PM related information downloaded form the PM related server and the PM related information produced by the operator are classified by a technique to have a schema structure.

While the invention has been shown and described with respect to the preferred embodiments, it will be understood by those skilled in the art that various changes and modifications may be made without departing from the spirit and scope of the invention as defined in the following claims.

What is claimed is:

1. A method for constructing a patent map (PM) database (DB) by employing a PM technique classification system and a technique classification PM DB, the method comprising the steps of:
(a) providing PM related information obtained by accessing a PM related server through Internet and generating PM related information produced by an operator of the PM technique classification system; and
(b) connecting a lower rank technique connection point and a higher rank technique connection point between technique classification columns in the DB by using the PM related information, allowing at least one bibliographical data to be described in the lowest technique classification column of the lowest rank and storing technique classification information in the technique classification PM DB.

2. The method of claim 1, wherein a highest technique classification column is linked to an intermediate technique classification column and the intermediate technique classification column is linked to the lowest technique classification column.

3. The method of claim 2, wherein the highest technique classification column and the intermediate technique classification column respectively include both a higher rank technique connection point and a lower rank technique connection point and the lowest technique classification column includes a higher rank technique connection point to be linked to the lower rank technique connection point in the intermediate technique classification column and said at least one bibliographical data.

4. The method of claim 3, wherein if there exists no next intermediate technique classification column, the lower rank technique connection point in the intermediate technique classification column is linked to the higher rank technique connection point in the lowest technique classification column.
